(19) United States
(12) Patent Application Publication
(10) Pub. No.: US 2010/0138391 A1
(43) Pub. Date: Jun. 3, 2010

(54) MANAGEMENT METHOD, MANAGEMENT PROGRAM AND MANAGEMENT APPARATUS OF DATABASE

(75) Inventors: Naoki NAMIKAWA, Yokohama (JP); Norihiro Hara, Kawasaki (JP); Masami Hikawa, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/485,565

(22) Filed: Jun. 16, 2009

(30) Foreign Application Priority Data
Dec. 2, 2008 (JP) 2008-307284

(51) Int. Cl. G06F 17/30

(52) U.S. Cl. 707/640; 707/E17.007

(57) ABSTRACT

A database management system includes a backup processing portion and a DB access processing portion. The backup processing portion operates to write data at a given time of a database stored in a storage unit out of the database after the given time as backup data. When an update request for data not written out as the backup data occurs in a data access request after the given time, the DB access processing portion writes the data at the given time out of the database as the backup data and updates the data written out of the database according to the update request. The backup processing portion and the DB access processing portion execute their processes in parallel.

### INCORPORATION BY REFERENCE

The present application claims priority from Japanese application JP2008-307284 filed on Dec. 2, 2008, the content of which is hereby incorporated by reference into this application.

### BACKGROUND OF THE INVENTION

The present invention relates to a database management method, a database management program and a database management apparatus.

With advancement of information society, many enterprises use systems provided with databases and supply various kinds of online services. The examples of those online services are banks' ATMs and air-ticket selling systems. As competitions among the enterprises are made harder and harder, today, to differentiate the enterprises from one another, the enterprises are more likely to prolong online service times and expand the contents of the online services.

In building an online service system, various kinds of hardware and middleware are often combined. This type of system is required to maintain not only the combined software and hardware parts each by each but also the overall system. It means that the management of this type of system is very costly.

Since the system management cost occurs constantly while the system is in operation, in order for one enterprise to get the better of the other ones in the competition, it is quite important to reduce the system management cost and thereby secure the profit. Hence, it is expected that the effective use of the time zone out of the online service time leads to the effective use of the system and giving rise to so high an outcome as meeting with the system management cost.

The database management system often operates to process the data accumulated in online services as a batch for the purpose of generating the statistical data and use the generated statistical data for supporting the management decision of an enterprise. The batch process to be executed in generating the statistical data requires the management system to access the massive amount of data, so that the load applied onto the system is likely to go higher during execution of the batch process.

In particular, when data is stored on an external storage medium such as a disk drive unit, the transfer of the data between the main body of the system and the external storage medium is made heavier. Hence, the batch process is often executed during the night time out of the online service time when the load applied onto the system is relatively light.

As the online services are expanded more and the online service users are made greater in number, the amount of data to be processed is increased and thereby the batch process time is made longer. On the other hand, each enterprise extends the online service time, so that the time to be allocated for the batch process is made shorter accordingly. Therefore, it is expected that the batch process time is made shorter.

In turn, the promotion of the batch process in the database management system will be described with reference to FIGS. 18 to 20, which are illustrated as explanatory Gantt charts with a time axis set to an axis of abscissas. The term “database management system” is a general configuration including a database management method, a database management program and a database management apparatus titled in the present invention.

FIG. 18 is an explanatory chart showing a backup process for each batch process b1 or b2.

When the system executes a plurality of batch processes, in order to make ready for any system failure, the data of the database at the batch process end times (t1, t3) are backed up (c1, c2).

In the conventional system promotion, in order to prevent a non-backed-up page on a database from being updated during the backup process (a data overwrite error), after the batch process is finished, the result of the batch process is backed up.

FIG. 19 is an explanatory chart showing the method of reducing the batch process time having been disclosed in the publication of: Jim Gray, Andreas Reuter, “Transaction Processing (Second Part)—Concept and Technique”, Nikkei BP Publishing, Ltd, October 2001, page 743.

The difference of the process shown in FIG. 19 from that shown in FIG. 18 is that the backup c1 of the result of the patch process b1 is executed in parallel to the batch process b2.

This method is executed to record the update logs L1 and L2 that are the update histories of the database when the batch process is executed.

Hence, if the data is overwritten on the database by the batch process b2, by writing back the update log L2 and the backup data bk1 previous to the overwrite onto the database, it is possible to execute the recovering process when a system failure occurs. (Refer to C. J. Date, “Introduction to Database Systems (Systems Programming Series”, Addison-Wesley Publishing, July 1982, page 20.) This recovering process makes it possible to keep the data on the database returned to the data at the time t1.

In the promotion of the method shown in FIG. 19, however, the recording process of the update log in executing the batch process makes the transfer of the data with the external storage unit increase the load applied onto the system dramatically.

To reduce the load applied onto the system (simply referred to as the system load), it may be designed to take the speed-up steps of putting the data stored on the external storage medium onto a memory and reading and writing the data stored in the memory. (This speed-up process is referred to as the in-memory data process.) This in-memory data process does not require the system to access the external storage unit. This is quite effective in reducing the system load.

In FIG. 20, the process is executed of reading the data from the external storage unit at a time t0 and storing the data in the memory. (This process is referred to as the in-memory process. Upon completion of the in-memory process, the batch process b1 is executed by reading and writing the data in the memory. When the batch process b1 is finished at a time t1, the process is executed of writing the data stored in the memory onto the external storage medium. (This process is referred to as the DB synchronization.)

When the DB synchronization is finished at a time t2, in a backup process c1, the data is read out of the external storage medium and is written as the backup data on the target storage medium. As mentioned above, to back up the data in memory, the DB synchronization is executed. After the DB synchronization is finished, the batch process b2 is executed.

To make ready for the data overwrite error, until the DB synchronization for the batch process b1 is finished, the system is required to keep the start of the next batch process b2 awaited. This waiting time makes the overall time of the batch processes (times t0 to t5) longer.

### SUMMARY OF THE INVENTION

It is therefore an object of the present invention to solve the foregoing problems and to reduce the processing time of the batch processes accompanied with the data backup in the database management system.

In carrying out the invention in a preferred mode, the present invention concerns with a database management method provided in a database management apparatus arranged to manage data saved in a database, which includes a data access processing portion and a backup processing portion, the backup processing portion operating to write data at a given time saved in the database stored in a storage unit as backup data out of the database the given time later, the data access processing portion operating to execute a data access to the database in response to a data access request for the database, in the data access request after the given time, when an update request for the data not to be written out as the backup data occurs, the data at the given time being written as the backup data out of the database, and then the data of the database being updated in response to the update request, and wherein the database management apparatus executes the process in the backup unit and the process in the data accessing unit in parallel.

The other component means will be described later.

The present invention is therefore effective in shortening the processing time of the batch process covering the data backup in the database management system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a database management system according to an embodiment of the present invention;

FIG. 2 is an explanatory table showing an example of data saved in a database included in the embodiment of the present invention;

FIG. 3 is a table showing an example of a DB access history included in the embodiment of the present invention;

FIG. 4 is a table showing an example of a backup schedule data to be created by the backup unit included in the embodiment of the present invention;

FIG. 5 is an explanatory chart showing a summary of a backup process to be executed by the database management system included in the embodiment of the present invention;

FIG. 6 is an explanatory table showing data values at a given time shown in FIG. 5 included in the embodiment of the present invention;

FIG. 7 is an explanatory chart showing data values at a given time shown in FIG. 5 included in the embodiment of the present invention;

FIG. 8 is an explanatory table showing data values at a given time shown in FIG. 5 included in the embodiment of the present invention;

FIG. 9 is an explanatory table showing data values at a given time shown in FIG. 5 included in the embodiment of the present invention;

FIG. 10 is an explanatory chart showing a summary of data recovering process in a first case included in the embodiment of the present invention;

FIG. 11 is an explanatory table showing data values at a given time shown in FIG. 10 included in the embodiment of the present invention;

FIG. 12 is an explanatory table showing data values at a given time shown in FIG. 10 included in the embodiment of the present invention;

FIG. 13 is an explanatory chart showing data values at a given time shown in FIG. 13 included in the embodiment of the present invention;

FIG. 14 is an explanatory table showing data values at a given time shown in FIG. 13 included in the embodiment of the present invention;

FIG. 15 is an explanatory table showing data values at a given time shown in FIG. 13 included in the embodiment of the present invention;

FIG. 16 is a flowchart showing a backup process by the normal write to be executed by the backup unit included in the embodiment of the present invention;

FIG. 17 is a flowchart showing a backup process by an extra write to be executed by the DB access unit included in the embodiment of the present invention;

FIG. 18 is an explanatory chart showing a backup process for each batch process according to a prior art of the present invention;

FIG. 19 is an explanatory chart showing the method of reducing a batch processing time according to a prior art of the present invention; and

FIG. 20 is an explanatory chart showing a backup process by saving data in a memory of the system from an external storage unit according to a prior art of the present invention.

### DESCRIPTION OF THE INVENTION

Hereafter, an embodiment of a database management system to which the present invention is applied will be described with reference to the appended drawings.

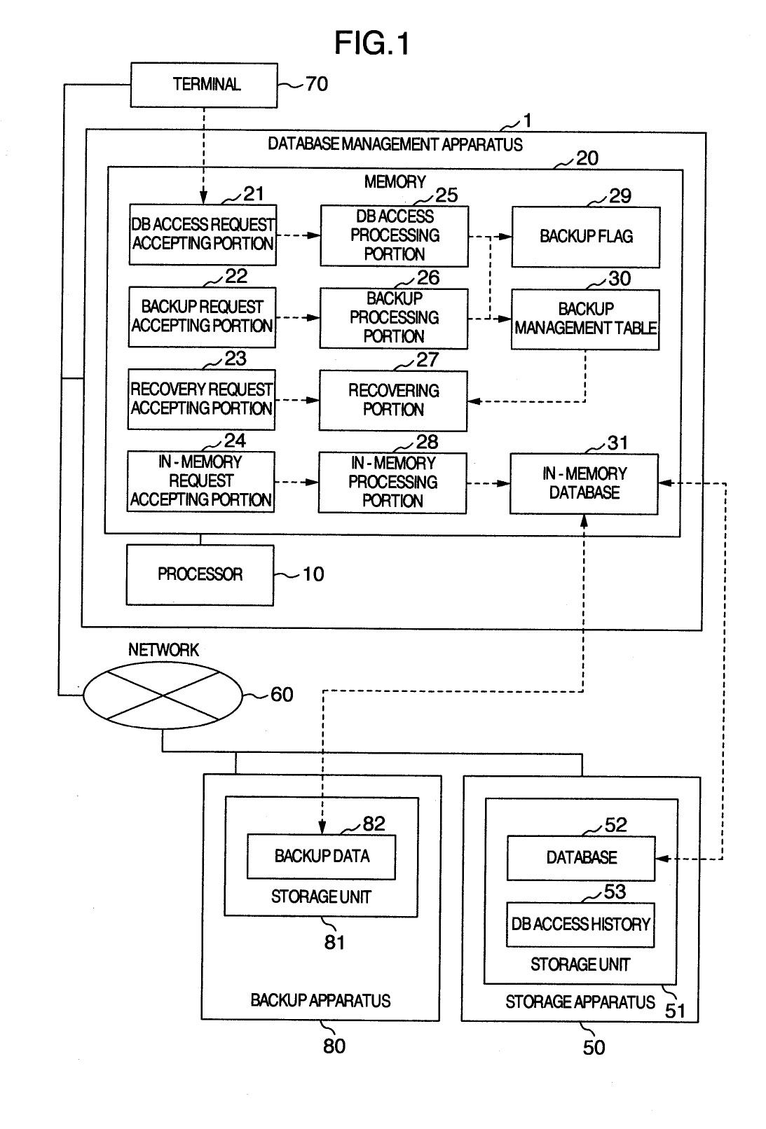

FIG. 1 shows a configuration of a database management system. The database management system includes a database management apparatus 1, a storage unit 50, a terminal 70, and a backup unit 80, all of which are connected with one another through a network 60.

The database management apparatus 1 is configured as a computer including a processor 10, a memory 20 and a communication interface through which the computer is communicated with another apparatus. The processor 10 composes the processing units for executing various kinds of processes by running the programs stored in the memory 20.

The memory 20 stores the programs, which compose a DB access request accepting portion 21, a backup request accepting portion 22, a recovery request accepting portion 23, an in-memory request accepting portion 24, a DB access processing portion 25, a backup portion 26, a recovering portion 27, and an in-memory processing portion 28, respectively.

The memory 20 stores as data a backup flag 29 that indicates the backup process is being executed, a backup management table 30, and an in-memory database 31.

The terminal 70 accepts a batch process for executing a batch service through an input unit through which the data is inputted from a user. The terminal 70 puts a transaction for executing the batch process between the database management apparatus 1 and the terminal 70 itself. If a data access is required during execution of the batch process, the terminal 70 operates to send a data access request or the like to the database management apparatus 1 through the transaction. The access request is described according to the SQL (Structured Query Language) rules, for example.

The database management apparatus 1 manages the data saved in each database (a database 52 and an in-memory database 31). The in-memory database 31 is created by storing the data of the database 52 in the memory (making the data of the database 52 the same as the data of the memory). The database management apparatus 1 controls the read and the write of the target data in response to a data access request sent from the terminal 70.

The storage apparatus 50 operates to save the data to be managed by the database management apparatus 1 in the database 52 of a storage unit 51 included in the storage apparatus 50 itself.

The storage apparatus 50 further stores as a DB access history 53 in the storage unit 51 a history of accesses having been made in response to a request for accessing the in-memory database 31 and the database 52.

Further, as the storage medium on which the database 52 and the DB access history 53 are stored, the storage apparatus 50 may have a storage unit 51 having a storage medium such as a HDD (Harddisk Drive) or an SSD (Solid-state Drive) built therein or another type of storage unit 51 like a DVD drive arranged so that a storage medium such as a readable and writable DVD (Digital Versatile Disc) may be loaded therein.

The backup apparatus 80 operates to store in a storage unit 81 the data of the in-memory database 31 managed by the database management apparatus 1 as backup data 82. The backup apparatus may be a storage device, an external storage medium directly connected with the database management apparatus 1, a tape device, or the like.

In the database management apparatus 1, the DB access request accepting portion 21 accepts the data access request sent from the terminal 70 or the like. The DB access processing portion 25 reads or writes the data saved in the in-memory database 31 in response to the data access request accepted by the DB access request accepting portion 21.

The DB access processing portion 25 accesses the data saved in the in-memory database 31 in response to an access request involved in the batch process. If the data access to the in-memory database 31 results in updating the data of the in-memory database 31, the DB access processing portion 25 executes the process of making the data of the in-memory database 31 the same as those of the database 52 on the synchronous or non-synchronous timing.

The backup request accepting portion 22 accepts the backup request sent from the terminal 70 or the like. The backup processing portion 26 backs up the data of the database 52 stored in the storage apparatus 50 and the in-memory database 31 in response to the backup request accepted by the backup request accepting portion 22.

The recovery request accepting portion 23 accepts a data recovery request sent from the terminal 70 or the like. The recovery processing portion 27 prepares the backup data required for the requested recovery from the backup data 82 in response to the data recovery request accepted by the recovery request accepting portion 23. The prepared backup data is reflected on the in-memory database so that the concerned data of the in-memory database 31 may be recovered.

The in-memory request accepting portion 24 accepts commands such as execution and release ones for processing the in-memory data. The in-memory processing portion 28 controls the in-memory data processing based on the command accepted by the in-memory request accepting portion 24.

The in-memory data processing means the process of putting the data to be managed, stored in the storage apparatus 50, in the memory 20 and accessing the in-memory database 31 stored in the memory 20 if the data access request is accepted. This process allows the in-memory processing portion 28 to eliminate the necessity of accessing the storage apparatus (database 52) provided as another apparatus, thereby being able to make the response to data access higher.

The database management apparatus 1 executes the backup process by writing the data of the in-memory database 31 being managed by the apparatus 1 itself onto the backup data 82 stored in the backup apparatus 80. This backup processing is implemented by any one of the following two writing processes.

The first sort of writing process is the “normal write”, which is the writing process to be executed by the backup processing portion 26. In particular, after the DB access processing portion 25 executes the committing process (the process of defining the data) about a predetermined transaction and then finishes the transaction, the backup processing portion 26 writes out the data of the in-memory database 31 including the data defined by the committing process onto the backup data 82.

The backup processing portion 26 creates a backup schedule data (see FIG. 4) about the data to be written out and the writing time, for example, after the transaction is finished. Based on the backup schedule data, the data to be backed up is written out page by page and is related with the writing time.

On the other hand, the backup processing portion 26 constantly measures a degree of load of the database management apparatus 1 without creating the backup schedule data in advance and defines the writing time of a page when the load of the database management apparatus 1 is made smaller than the predetermined degree. That is, the so-called dynamic backup control is carried out.

The second sort of writing process is the “extra writing”, which is the writing process to be executed by the DB access processing portion 25. The data to be written out as the backup data 82 is not the latest data but the data at a predetermined time (for example, the end time of a predetermined transaction).

On the other hand, within the in-memory database 31, a data value in the page about which the data writing is not finished may be rewritten as the latest data value by the data access process of the latest transaction.

To cope with this unfavorable rewrite, if the update of the data value to a page where no backup is executed by the “normal writing” takes place in the transaction being currently processed, the DB access processing portion 25 writes out the data value in the non-updated page on behalf of the backup processing portion 26 and writes the data value in the updated page of the in-memory database 31.

The aforementioned backup processes based on the “normal writing” and the “extra writing” are both the process of writing the data from the in-memory database 31 to the backup data 82. However, these writing processes are executed by their components. (The writing process based on the “normal writing” is executed by the backup processing portion, while the writing process based on the “extra writing” is executed by the DB access processing portion 25.)

Hence, to prevent occurrence of collision of data accesses between the data writing processes executed by the DB access procession portion 25 and the backup processing portion 26, the database management apparatus 1 executes the following exclusive process.

One of the DB access processing portion 25 and the backup processing portion 26 operates to check if the other processing portion is executing the data writing process before the backup process is started. If the other processing portion is executing the data writing process, the processing portion for checking for it has to stay in the waiting state until the other processing portion finishes the writing process.

The backup flag 29 indicates if the backup process is being executed. It thus has any one value of “being processed” and “unprocessed”. When the flag 29 has a value of “being processed”, it indicates the backup is under process, while when the flag 29 has a value of “unprocessed”, it indicates the backup is not processed.

When the flag 29 indicates the “being processed”, it is determined if the DB access processing portion 25 needs to execute the data writing process, while when the flag 29 indicates the “unprocessed”, it is not determined if the DB access processing portion 25 needs to do the writing process.

Further, as to the same page, just one of the “normal writing” backup process and the “extra writing” backup process is required. Hence, the database management apparatus 1 manages the progress of the backup process of each page in the backup management table 30.

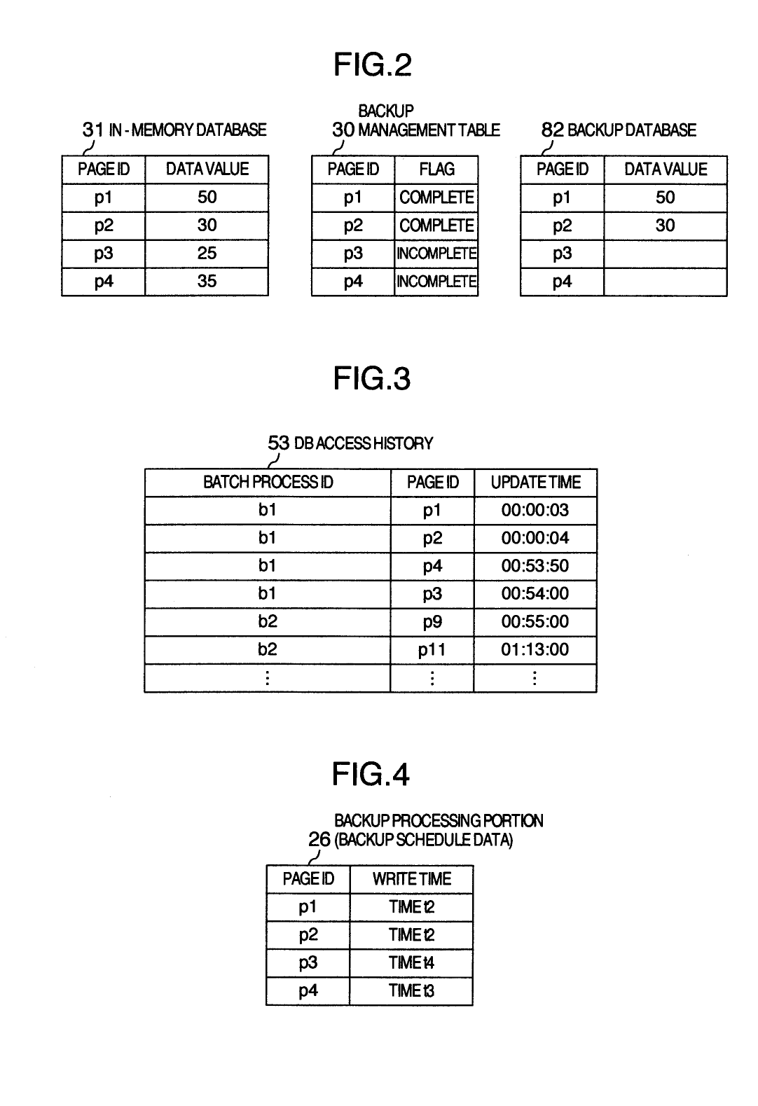

FIG. 2 shows the exemplary tables of the in-memory database 31, the backup management table 30 and the backup data 82.

The in-memory database 31 and the backup data 82 are the storage areas on which the data to be saved in the database 52 are stored. The data is managed with a “page ID” and a “data value in the page” matched to each other.

Further, the input and output of data among the in-memory database 31, the backup date 82 and the database 52 is carried out page by page.

In FIG. 2, as page data, one page has one integer (e.g. “50”). This is illustrative for description's sake. In actual, on one page is stored various kinds of data of a fixed length and a variable length (such as binary data and text data) to be treated by the database.

The backup management table 30 is a table for saving the information that indicates if a page has been already backed up in each page of the in-memory database 31. The table 30 manages a “page ID” to be used for specifying a page to be backed up and a “flag” that indicates if a page has been backed up with both of the “page ID” and the “flag” being matched to each other.

The “flag” takes any one of the values “complete”, which indicates that a page has been backed up, and “incomplete”, which indicates that a page is not backed up yet.

One of the DB access processing portion 25 and the backup processing portion 26 executes the backup of the page with the flag of “incomplete” and then changes the flag from “incomplete” into “complete”. The other processing portion skips the backup of the page with a flag of “backed”. This function makes it possible to prevent the so-called “double backup”, that is, duplicate write of the page by one processing portion though the page has been already written out by the other processing portion.

FIG. 3 is a table showing an exemplary DB access history 53. The DB access history 53 manages a batch process ID, a page ID and an update time with those matched to one another.

When executing the data update of the in-memory database 31 in a batch process, the DB access processing portion 25 writes in the DB access history 53 the ID of the batch process, the page ID whose data is to be updated and an update time in a manner to make them matched to one another.

FIG. 4 is a table showing an exemplary backup schedule data to be created by the backup processing portion 26.

In the backup schedule data, a page ID and a scheduled writing time of a page of the ID are described for each page to be backed up. The page ID is matched to the scheduled writing time thereof.

The backup processing portion 26 may execute the normal writing process of each page on the timing according to the backup schedule data or write out pages in earlier sequence of the page writing times. The backup schedule data may be created by the backup processing portion 26 or arranged as the data having been inputted from the terminal 70 or the like.

It is expected that the backup schedule data is arranged so that the database management apparatus 1 keeps the processing load substantially even at any processing time. This is because if a massive amount of pages are backed up on a specific period, the heavy processing load applied by the backup process brings pressure onto the data access executed by the DB access processing portion 25, so that the adverse effect is given to the transaction processing.

Further, if a frequency of the “extra write” is made higher in the DB access processing portion 25, the adverse effect is also given to the processing time of the transaction or the batch process.

To overcome these shortcomings, the backup processing portion 26 executes any one of the following two creating methods, which results in predicting the current and the future data accesses based on the past DB access history 53 with high accuracy and creating the backup schedule data being highly effective in distributing the processing load based on the prediction.

The first creating method is a method of creating the backup schedule data based on the update sequence of the pages extracted from the DB access history 53.

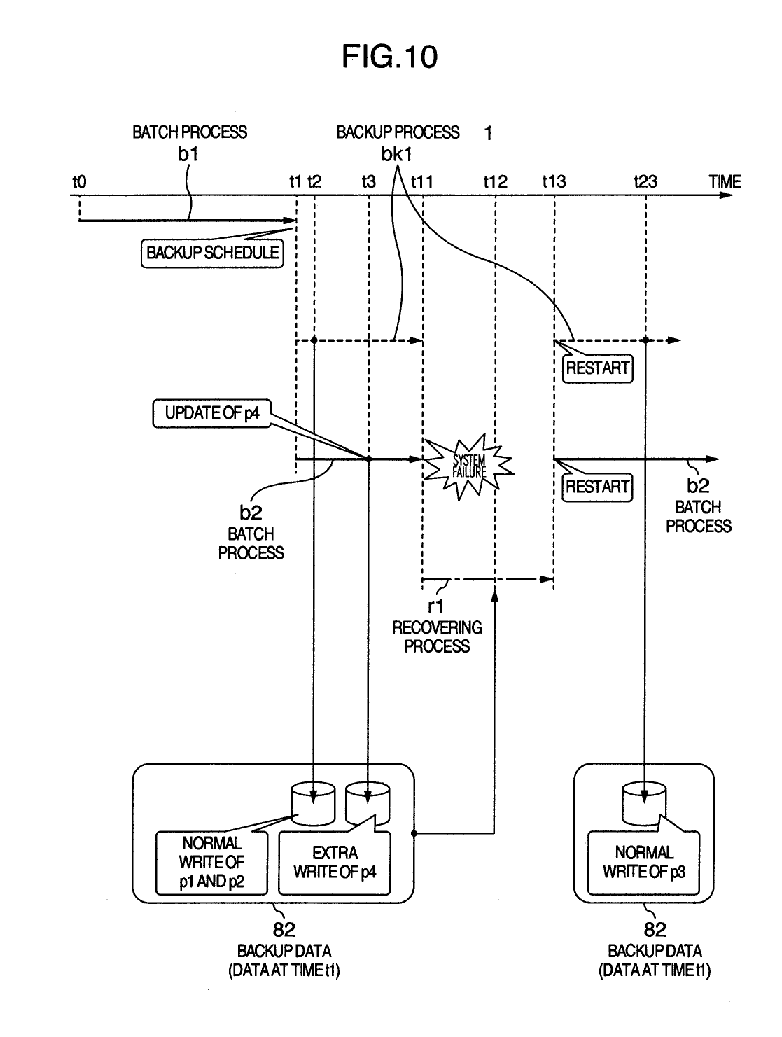

In the DB access history 53 shown in FIG. 3, for example, it is to be understood that the history of the batch process ID “b1” is the earlier sequence of the update times such as the page ID “p1” to “p2” to “p4” to “p3”. Hence, as indicated in the backup schedule data shown in FIG. 4, the pages to be backed up are arranged in the same sequence of “p1” to “p2” to “p4” to “p3”. Herein, the (later) writing times are ranged in the laser sequence of “t2” to “t3” to “t4” as will be shown in FIG. 10.

In this schedule data, the page “p1” of the earlier writing times in the past is preferentially processed in the future backup process. The page “p3” of the later writing times in the past is postponed in the future backup process.

The second creating method is a method of creating the backup schedule data based on the average of the update sequence of the pages extracted from the DB access history 53. For example, it is assumed that about the pages “p1” to “p4”, the average of the update sequence of the pages extracted from the DB access history 53 is as shown. Herein, the “First rank” means that the “First-rank” page of the four pages is backed up at the earliest (the most previous) time.

Page “p1”: 1.2nd Rank

Page “p2”: 2.5th Rank

Page “p3”: 2.9th Rank

Page “p4”: 3.7th Rank

The backup processing portion 26 creates the backup schedule data in which the page IDs are arranged in the better average (the less valued) sequence, that is, in the sequence of “p1” to “p2” to “p3” to “p4”.

The aforementioned two creating methods make it possible to enhance a possibility of bringing about the “normal write” according to the backup schedule data more than the “extra write” with respect to each page.

The lower frequency of the “extra write” allows the DB access processing portion 25 to allocate a more processing capability to the transaction being currently processed.

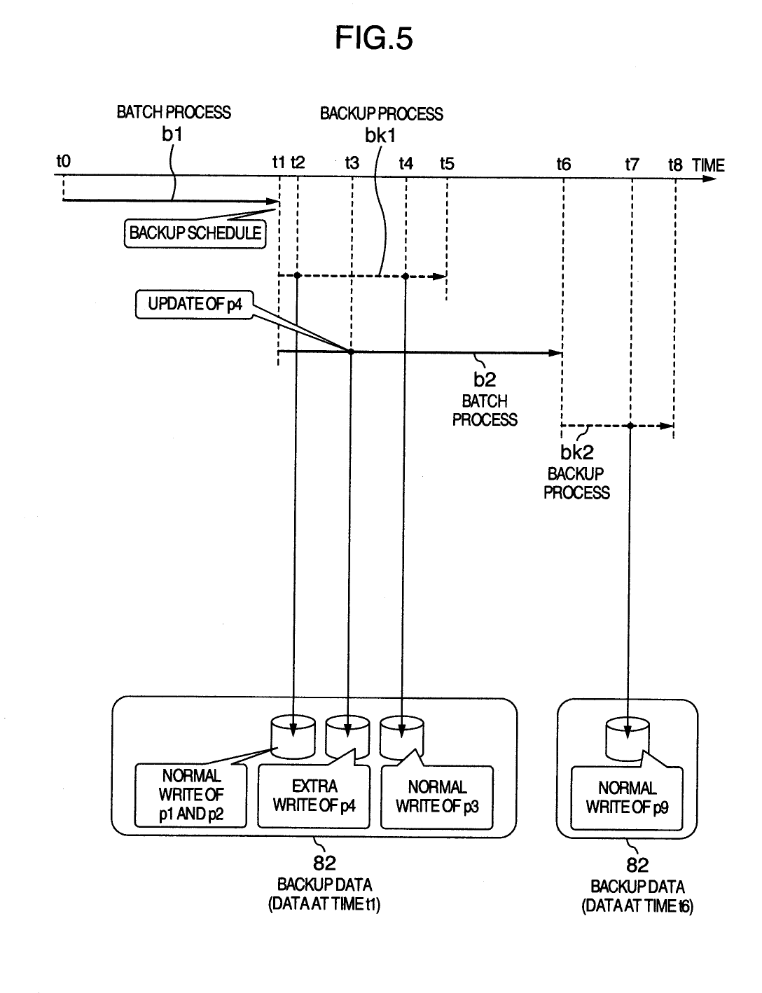

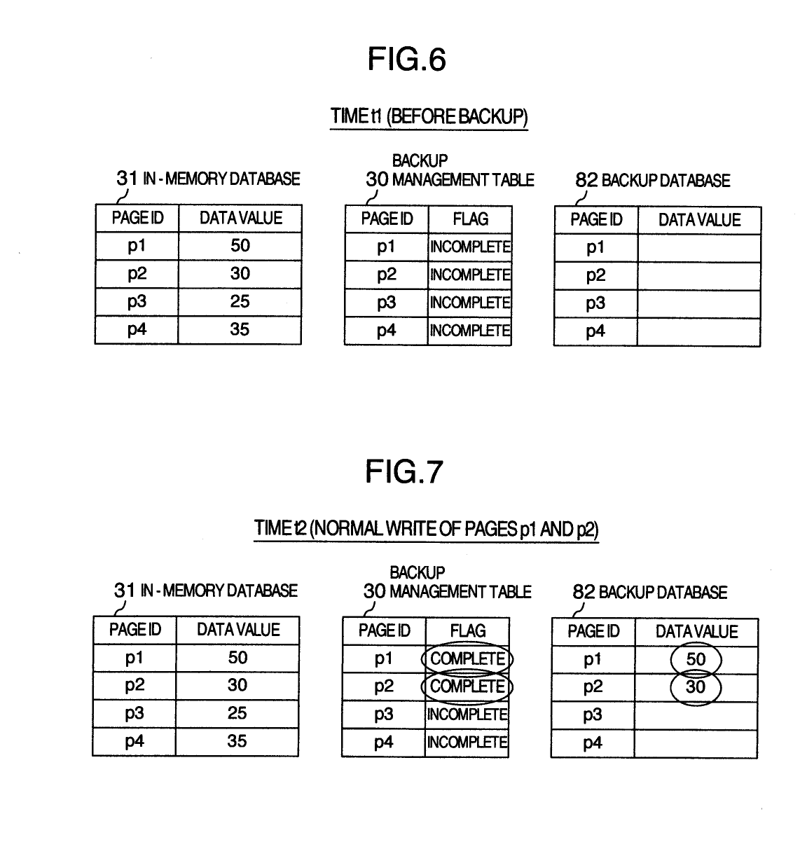

FIG. 5 is an explanatory chart showing a summary of a backup process to be executed by the database management system. Hereafter, the backup process shown in FIG. 5 will be described arbitrarily with reference to FIGS. 6 to 9. The chart of FIG. 5 takes a Gantt type with an axis of abscissa as a time axis. In the vertical direction of FIG. 5, the batch processes b1 and b2 to be executed by the terminal 780 and the DB access processing portion 25 are shown by a solid arrow, while the backup processes bk1 and bk2 to be executed by the backup processing portion 26 are shown by a dotted arrow.

The backup process bk1 is a process of writing out the data of the in-memory database 31 at an end time (time t1) of the batch process b1 to the backup data 82. The backup process bk2 is a process of writing out the data of the in-memory database 31 at the end time (time t6) of the batch process b2 to the backup data 82. In addition, the backup processing portion 26 puts the backup processing flag 29 at “processing” mode before executing the backup processes bk1 and bk2 and then puts the flag 29 at “non-processed” mode after executing these processes.

At a time t0, the terminal 70 starts the batch process b1 and the DB access processing portion 25 reads and writes the pages saved in the in-memory database 31. Herein, the in-memory database 31 has been already stored in the memory.

At a time t1, the terminal 70 finishes the batch process b1, when the terminal 70 and the DB access processing portion 25 start the next batch process b2. At a time, the backup processing portion 26 creates the backup schedule data (see FIG. 4) on which the pages (p1 to p4) of the in-memory database 31 at the time t1 are to be written out to the backup data 82.

The backup schedule data is created by rearranging the pages (p1, p2, p3, p4) to be backed up in the sequence of the pages to be updated earlier by the batch process b1, that is, the sequence of p1 to p2 to p3 to p4.

As shown in FIG. 6, at the time t1 before executing the backup process, the data of the in-memory database 31 is not written out to the backup data 82. The backup processing portion 26 initializes the flag of the backup management table 30 for the page to be backed up as “incomplete”.

As shown in FIG. 7, at time t2 when the pages p1 and p2 are to be written out as indicated by the backup schedule data in the backup process bk1, the backup processing portion 26 reads the data of the pages p1 and p2 from the in-memory database 31 in the sequence of the pages p1 to p2 and writes out the read data onto the backup data 82. (It corresponds to the normal write.) The backup processing portion 26 changes the flag of the concerned pages (p1 and p2) of the backup management table 30 into “complete”.

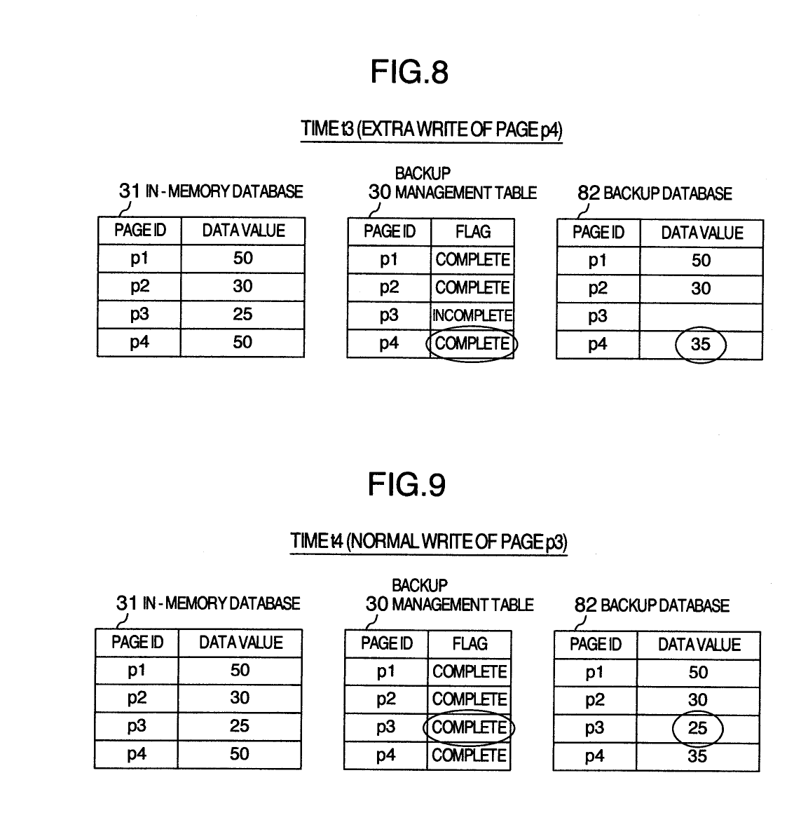

As shown in FIG. 8, at time t3, during execution of the batch process b2, it is assumed that the terminal 70 requests DB access processing portion 25 to execute the data update of the page p4 that is not backed up yet.

The DB access processing portion 25 writes out the data “35” of the page p4 that is not updated on behalf of the backup processing portion 26. (It corresponds to the extra write.) At a time, the DB access processing portion 25 writes the updated data “50” in the in-memory database 31. In this extra write, the DB access processing portion 25 changes the flag of the page p4 of the backup management table 30 into “complete”.

As shown in FIG. 9, at a time t4, when the page p3 is to be written out as indicated by the backup schedule data in the backup process bk1, like the pages p1 and p2, the backup processing portion 26 executes the normal write to the backup data 82 and updates the flag of the backup management table 30.

Afterwards, at a time t5, when though the write time of the page p4 comes as indicated by the backup schedule data, the extra write has been already executed at the time t3 in the backup process bk1, the backup processing portion 26 skips the backup process of the page p4 and finishes the backup process bk1. The backup processing portion 26 determines the skip of the backup process of the page p4 if the flag of the table 30 for the page 4 is set to “complete”.

The foregoing backup process bk1 makes it possible to make the data (see FIG. 6) of the in-memory database 31 at the time t1 identical with the backup data 82 at the time t4.

The foregoing description has concerned with the backup process of the data from the in-memory database 31 to the backup data 82. In turn, the description will be oriented to the two cases of recovering (writing back) the data from the backup data 82 to the in-memory database 31 if a system failure occurs in the batch process. This recovery is executed by the recovering portion 27.

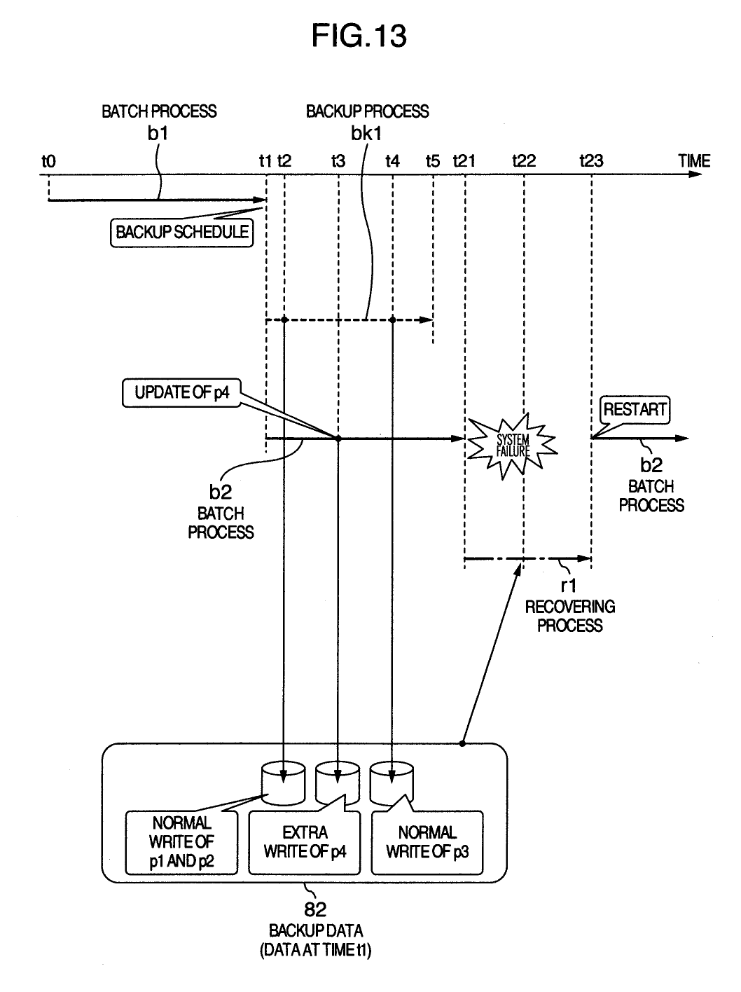

The first case concerns with the case that a system failure occurs before the backup process bk1 is completed as shown in FIGS. 10 to 12. The second case concerns with the case that a system failure occurs after the backup process bk1 is completed as shown in FIGS. 13 to 15.

FIG. 10 is an explanatory chart showing a summary of a data recovering process in the first case. Like FIG. 5, this chart is a Gantt type with a time axis set to an axis of abscissa.

The process at times t0 to t5 holds true to the process shown in FIG. 5. That is, the backup processing portion 26 executes the normal write of the pages p1 and p2 according to the backup schedule data (see FIG. 4). Then, when the page p4 is updated, the DB access processing portion 25 executes the extra write of the page p4.

When the batch process b2 and the backup process bk1 are executed in parallel at a time t11, a system failure occurs in the batch process. In response to a report on failure occurrence sent from the DB access processing portion 25, the backup processing portion 26 stops the backup process bk1 and executes the recovering process r1 of the in-memory database 31.

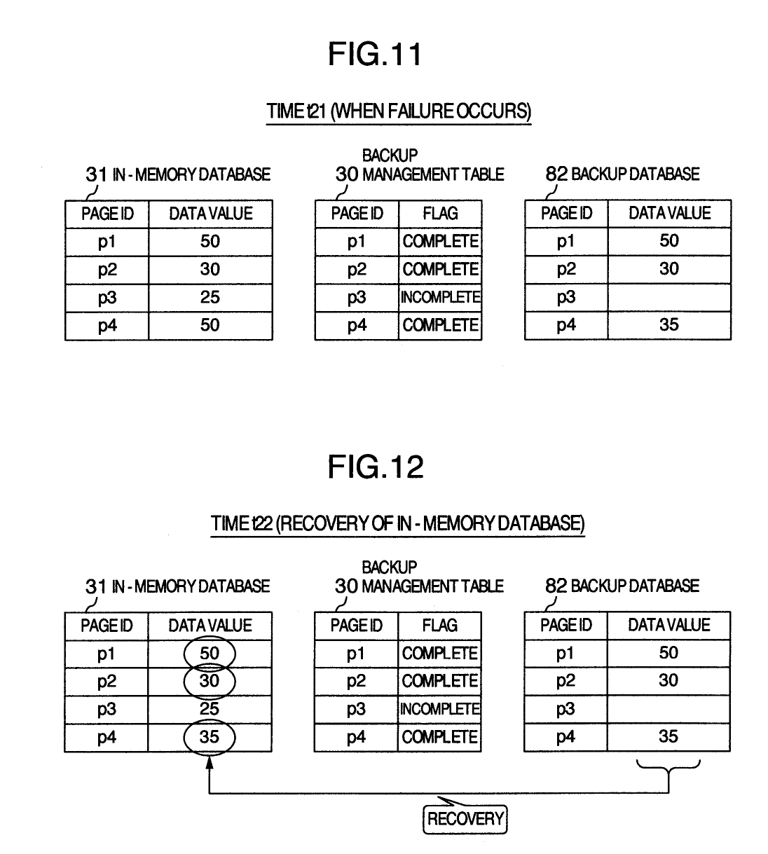

As shown in FIG. 11, at the time t11, the backup data 82 includes the data of the pages p1, p2 and p4. The backup processing portion 26 specifies as the pages to be recovered the pages p1, p2 and p4 with a flag “complete” set thereto by referring to the flags of the backup management table 30.

As shown in FIG. 12, the backup processing portion 26 reads the data values of the pages p1, p2 and p4 from the backup data 82 and writes the read data back to the in-memory database 31.

This write-back process results in making the data of the in-memory database 31 recovered as the data at the time t1. Going back to FIG. 10, after the recovering process r1 is finished, the terminal 70 and the DB access processing portion 25 start the batch process b2 again and the backup processing portion 26 starts the backup process bk1 again.

FIG. 13 is an explanatory chart showing a summary of a data recovering process in the second case.

The process at the times t0 to t5 holds true to the process shown in FIG. 5. That is, the backup processing portion 26 executes the normal write of the pages p1, p2 and p3 according to the backup schedule data (see FIG. 4). Then, when the page p4 is updated, the DB access processing portion 25 executes the extra write of the page p4. Further, upon completion of backing up the pages p1 to p4, the backup processing portion 26 finishes the backup process bk1.

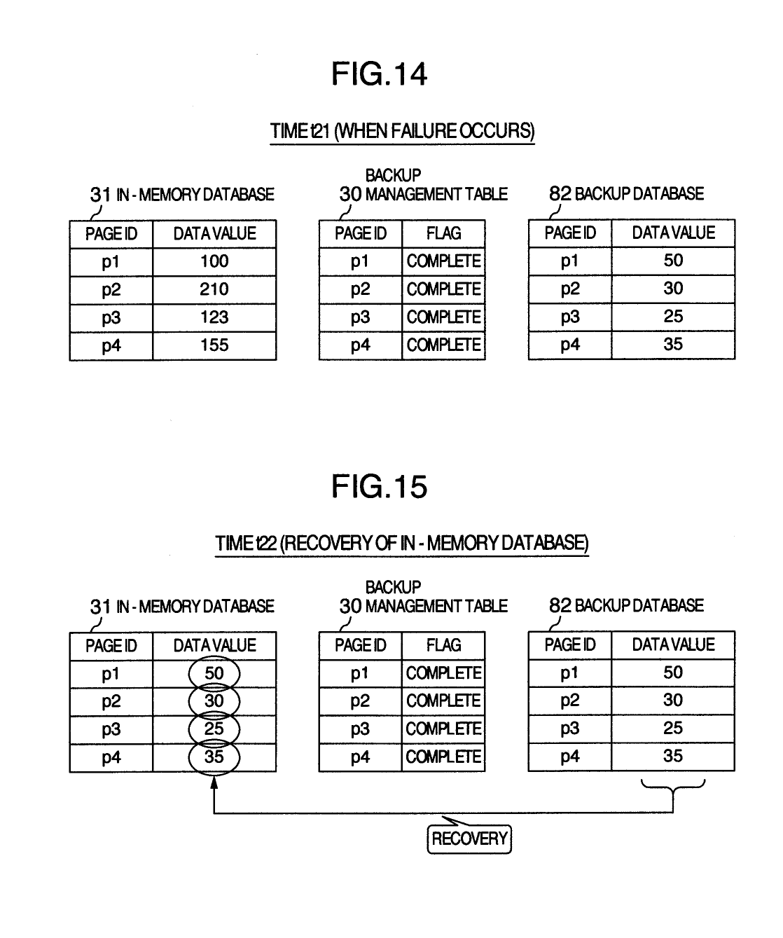

As shown in FIG. 14, when a system failure occurs in the batch process b2 at a time t21, the terminal 70 and the DB access processing portion 25 stop the batch process b2 and make a request to the backup processing portion 26 for the recovering process r1 of the in-memory database 31.

As shown in FIG. 15, at a time t22, the backup processing portion 26 writes the backup data 82 at the time t1 back to the in-memory database 31. The different respect of FIG. 15 from FIG. 12 is that the flags of the backup management table 30 are all set to “incomplete”.

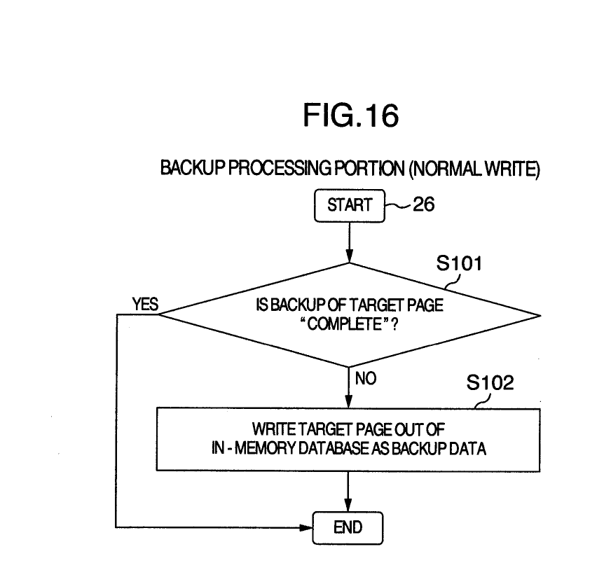

FIG. 16 is a flowchart showing the normal write backup process to be executed by the backup processing portion 26.

This flow of process is executed for each page to be backed up (referred to as the target page) each time the write time of a target page or the write sequence thereof comes.

In step S101, the backup processing portion 26 refers to the backup management table 30. If the target page backup is “complete” (Yes in S101), the backup processing portion 26 skips the backup process and then finishes the process.

In step S102, if the target page backup is “incomplete” (No in S101), the backup processing portion 26 reads the data value of the target page from the in-memory database 31 and writes the read data value out to the backup data 82.

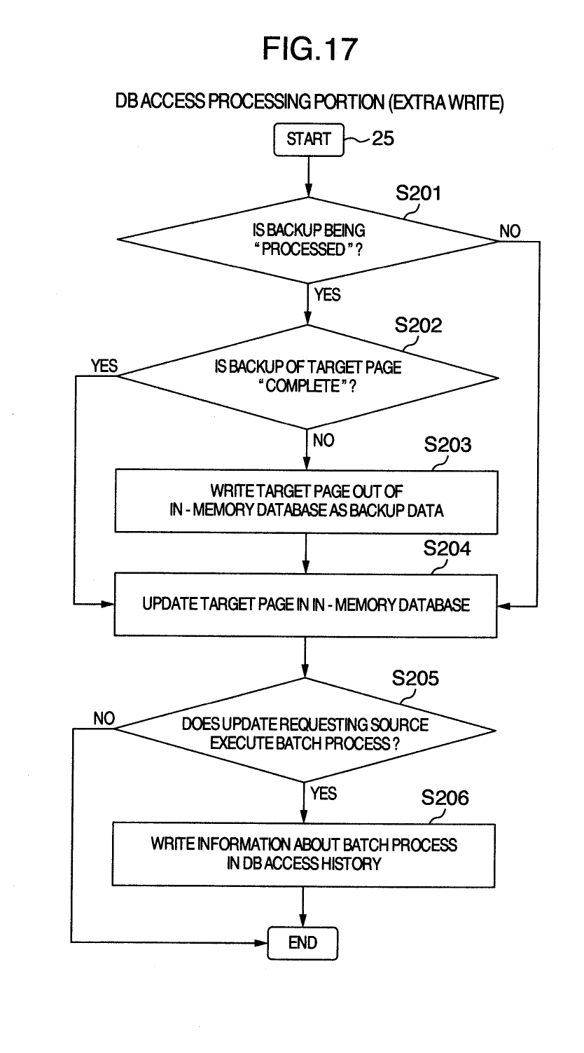

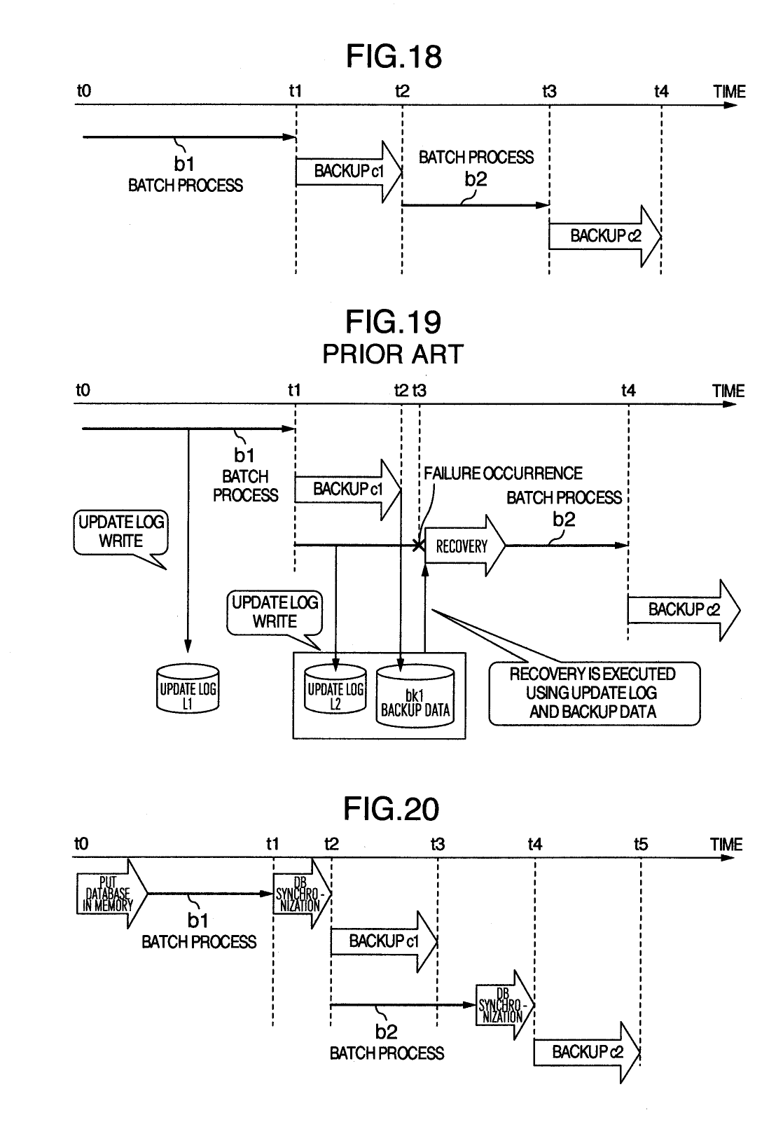

FIG. 17 is a flowchart showing the extra write backup process to be executed by the DB access processing portion 25. This flow of process is executed for each target page when the DB access processing portion 25 updates the data value of the target page at a backup target time through a data access involved in the batch process.

In step S201, the DB access processing portion 25 refers to the backup flag 29. If the backup processing portion 26 keeps the normal write “being processed” (Yes in S201), the portion 25 goes to a step S202, while if the portion 26 keeps the normal write “unprocessed” (No in S201), the portion 25 goes to a step S204.

In the step S202, the DB access processing portion 25 refers to the backup management table 30. If the target page backup is “complete” (Yes in S202), the portion 25 skips the backup process and goes to the step S204.

In a step S203, If the target page backup is “incomplete” (No in S202), the DB access processing portion reads the data value of the target page that are not updated from the in-memory database 31 and then writes out the data value to the backup data 82.

In the step S204, the DB access processing portion 25 writes the updated data of the target page out to the in-memory database 31.

In a step S205, the processor 10 of the database management apparatus 1 determines if the requesting source for data update to be executed in the step S204 is the terminal 70. If the determining condition is met (Yes in S205), the DB access processing portion 25 goes to a step S206, while if it is not met (No in S205), the portion 25 finishes the process.

In the step S206, about the data updated and written in the in-memory database 31 in the step S204, the DB access processing portion 25 writes in the DB access history 53 the batch process ID of the batch process being executed, the ID of the page whose data value is to be updated and the data update time in a manner so that those factors may be matched to one another.

As set forth above, the database management method and apparatus according to the embodiments of the invention provide a capability of executing the backup process and the batch process in parallel and thereby shortening the total required time of the batch process and the promotion service.

Even if the backup process and the batch process are simply combined so that those processes are executed in parallel, the data overwrite problem takes place.

In the foregoing embodiments, when the data overwrite takes place, the erase of the target page by the overwrite can be avoided by executing the extra write.

In the foregoing embodiments, by creating the highly accurate backup schedule data based on the data access history extracted from the DB access history 53, it is possible to lessen an execution frequency of the extra write that has an adverse effect on the batch process.

It should be further understood by those skilled in the art that although the foregoing description has been made on embodiments of the invention, the invention is not limited thereto and various changes and modifications may be made without departing from the spirit of the invention and the scope of the appended claims.

1. A database management method to be executed by a database management apparatus for managing data saved in a database, the database management apparatus having a data access processing portion and a backup processing portion, comprising the steps of:
causing the backup processing portion to write as backup data the data saved in the database at a given time from the database after the given time; and
causing the data access processing portion to execute a data access to the database in response to a data access request for the database, write the data at the given time out of the database as the backup data when an update request for the data that is not written out as the backup data takes place in the data access request after the given time and then to update the data saved in the database according to the update request; and
wherein the database management apparatus executes the process of the backup processing portion and the process of the data access processing portion in parallel.

2. The database management method as claimed in claim 1, wherein the database management apparatus specified the database to be accessed as an in-memory database to be located in a memory included in the apparatus and specifies a storage unit into which the data is to be written as the backup data from the database as a storage unit to be accessed by the apparatus.

3. The database management method as claimed in claim 1, wherein the database management apparatus stores in the storage unit backup management data for each data unit of the database, the backup managing data indicating if each data unit has been backed up, and the backup processing portion and the data access processing portion set a “complete” flag to the predetermined data of the backup management data about the data written out as the backup data, check if the “complete” flag is set to the predetermined data of the backup management data before writing out the predetermined data as the backup data and, if the predetermined data is backed up, skips the process of writing out the predetermined data.

4. The database management method as claimed in claim 1, wherein when one of the backup processing portion and the data access processing portion starts the backup process, one of the processing portions checks if the other processing portion is executing the process of writing out the data before one processing portion writes out the predetermined data as the backup data, if the other processing portion is executing the process, one processing portion puts itself in a waiting state before the other processing portion finishes the writing process.

5. The database management method as claimed in claim 1, wherein when the data access processing portion executes the data access to the database, the data access processing portion stores in the storage unit an ID of the data unit to be accessed and an execution time of the data access as a data access history in a manner that the ID and the execution time are matched to each other, and the backup processing portion refers to the execution time for each past data unit stored in the data access history and writes out as the backup data the earlier accessed data units earlier.

6. The database management method as claimed in claim 1, wherein when the data access processing portion executes the data access to the database, the data access processing portion stores in the storage unit an ID of a data unit to be accessed and an execution time of the data access as a data access history in a manner that the ID and the execution time are matched to each other, and
the backup processing portion refers to the execution for each past data unit stored in the data access history, calculates an average sequence of the execution times of the data units, and writes out as the backup data the data units in the earlier average sequences earlier.

7. The database management method as claimed in claim 1, wherein the database management apparatus further includes a recovering portion, and
when the recovering portion accepts a data recovering request for the database later than the given time, the recovering portion writes the backup data at the given time written out by the backup processing portion and the data access processing portion back to the database.

8. The database management program causing the database management apparatus composed of a computer to execute the database management method as claimed in claim 1.

9. A database management apparatus for managing data saved in a database, comprising:
a backup processing portion for writing data at a given time of the database stored in a storage unit out of the database after the given time as backup data; and
a data access processing portion for executing a data access to the database in response to a data access request for the database, when an update request for data not written out as the backup data occurs in the data access request after the given time, the data access processing portion writing out the data at the given time as the backup data from the database and updating the data of the database according to the update request; and
wherein the backup processing portion and the data access processing portion execute their processes in parallel.
